(19) United States
(12) Patent Application Publication
(10) Pub. No.: US 2024/0033891 A1
(43) Pub. Date: Feb. 1, 2024

(54) Method for Documenting Operating Data of a Hand-Held Power Tool

(71) Applicant: Robert Bosch GmbH, Stuttgart (DE)

(72) Inventors: Joerg Lemmel, Weinstadt (DE); Daniel Vesenmaier, Leinfelden-Echterdingen (DE)

(21) Appl. No.: 18/258,270

(22) PCT Filed: Dec. 16, 2021
(86) PCT No.: PCT/EP2021/086119

§ 371 Date: Jun. 19, 2023

(30) Foreign Application Priority Data
Dec. 21, 2020 (DE) 10 2020 216 381.2

(51) Int. Cl. B25F 5/00

(52) U.S. Cl. CPC B25F 5/00

(57) ABSTRACT

A method for documenting operating data of a hand-held power tool using a data processing device, in particular a data logger, includes at least one communication step in which operating parameters of the hand-held power tool are retrieved via a communication unit of the data processing device, and at least one processing step, in which the operating parameters of the hand-held power tool are processed into compressed operating data by a computing unit of the data processing device in order to reduce the storage requirement. The method further includes a storage step in which the operating data of the hand-held power tool which is processed by the computing unit, in particular compressed, is stored on a storage unit of the data processing device.

### THE PRIOR ART

A method has already been proposed for documenting operating data of a hand-held power tool using a data processing device, in particular a data logger, having at least one communication step in which operating parameters of the hand-held power tool are retrieved via a communication unit of the data processing device; at least one processing step, in which the operating parameters of the hand-held power tool are processed into compressed operating data by a computing unit of the data processing device in order to reduce the storage requirement; and a storage step in which the operating data of the hand-held power tool which is processed by the computing unit, in particular compressed, is stored on a storage unit of the data processing device.

### DISCLOSURE OF THE INVENTION

The invention proceeds from a method for documenting operating data of a hand-held power tool using a data processing device, in particular a data logger, having at least one communication step in which operating parameters of the hand-held power tool are retrieved via a communication unit of the data processing device; at least one processing step, in which the operating parameters of the hand-held power tool are processed into compressed operating data by a computing unit of the data processing device in order to reduce the storage requirement; and a storage step in which the operating data of the hand-held power tool which is processed by the computing unit, in particular compressed, is stored on a storage unit of the data processing device.

It is proposed that the computing unit classifies data of at least one received operating parameter of the hand-held power tool in the processing step in order to generate the compressed operating data and/or the computing unit evaluates the data in order to detect a defined event. Preferably, the data of at least one received operating parameter of the hand-held power tool is classified and/or evaluated in order to detect a defined event in order to reduce a later storage requirement. The data of the received operating parameters of the hand-held power tool is in particular formed by raw data. Alternatively or additionally, the data of the received operating parameters of the hand-held power tool can already be preprocessed by an electronics unit of the hand-held power tool. Further processing within the hand-held power tool is also possible, e.g., for predictive maintenance, for user application recommendations, for an AI, and/or the like.

The data processing device is in particular formed by a separate module and/or by an application on a device separate from the hand-held power tool. The data processing device is provided for documenting operating data of the hand-held power tool. In particular, the data processing device is provided in order to document, in particular to store, operating data of the hand-held power tool, independently from the hand-held power tool and in particular from the integrated electronics unit of the hand-held power tool. Additionally, the data processing device can be provided to evaluate the operating data of the hand-held power tool. It is in particular conceivable that the data processing device can be provided for an automatic evaluation of the operating data of the hand-held power tool and/or for an automatic adjustment of characteristics of the hand-held power tool as a function of the documented operating data. It is further conceivable that the compressed operating data be automatically retrieved and/or transferred to a server and/or manually retrieved for evaluation. The compressed operating data can be retrieved for error analysis, optimization of the hand-held power tool, and/or adjustment of operating parameters of the hand-held power tool. Further evaluations which a skilled person regards as advantageous are also conceivable.

The data processing device is in particular formed by a data logger, preferably a mini-data logger, which is connected to the regular electronics unit of the hand-held power tool and stores data that has been processed by the electronics unit. This data can be pre-processed in the data processing device and transferred wirelessly to further devices. In the electronics unit of the hand-held power tool, there is a variety of data, in particular operating parameters, such as current, voltage, temperatures, vibrations, accelerations, or the like. The storage capability of the electronics unit of the hand-held power tool is typically strongly limited, so the data is stored on the additional data processing device. The data are transferred from the electronics unit of the hand-held power tool to the data processing device and stored therein. In particular, the data can be processed using the data processing device both before and after storage. Processing is in particular performed in order to reduce a storage requirement. In addition to a classification and detection of events, processing can be performed additionally or alternatively by a fast Fourier transformation, a filtering, a multiplication, an addition, a subtraction, an integration, a mean determination, by RMS, or the like.

A “hand-held power tool” is intended in particular to mean a workpiece-processing machine, advantageously a drilling machine, a drilling and/or impact hammer, a saw, a planer, a screwdriver, a milling machine, a grinder, an angle grinder, a gardening tool, and/or a multifunction tool.

In particular, stored data of the electronics unit of the hand-held power tool are retrieved using the communication unit by way of the data processing device. The stored data can in particular be read out by cable or transferred wirelessly, for example via Bluetooth, mobile radio, LoRa, WiFi, or the like. In this context, a “communication unit” is understood in particular to mean a unit intended to provide communication, in particular wirelessly, with the hand-held power tool, in particular between the data processing device and the hand-held power tool, in particular a communication link. Preferably, the communication unit for communicating with the hand-held power tool comprises at least one interface. Preferably, a communication unit is understood in particular as a unit provided for the exchange of data. In particular, the communication unit comprises at least one information input and at least one information output. Preferably, the communication unit comprises at least two information inputs and at least two information outputs, whereby at least one information input and at least one information output are provided for a respective connection to a physical system. Particularly preferably, this is understood to be an interface between at least two physical systems, in particular between the hand-held power tool and the data processing device. There are a variety of a communication units which a skilled person will consider advantageous. In particular, however, this is understood to mean a wireless interface such as Bluetooth, Wi-Fi, ZigBee, NFC, RFID, GSM, LTE or UMTS, and/or a wired interface, such as a USB port, a CAN bus interface, an RS485 interface, an SPI bus interface (Serial Peripheral Interface), an Ethernet interface, an optical interface, a KNX interface, and/or a powerline interface. A “communication connection” is intended in particular to mean a connection through which a computing unit is or becomes connected to further computing units and/or to sensor units, whereby the units can communicate with one another and exchange data and/or control signals.

The term “computing unit” is understood in particular to mean a unit having an information input, information processing, and an information output. Advantageously, the computing unit comprises at least one processor, a storage, input and output means, further electrical components, an operating program, regulating routines, control routines, and/or calculation routines. The components of the computing unit are preferably arranged on a common board and/or advantageously arranged within a common housing. In particular, the term “storage unit” is intended to mean a unit provided in order to store at least one piece of information, advantageously independently of a power supply. The storage unit can in particular be designed as a part of the operator terminal and can be formed by an external storage unit, in particular a server. Preferably, the operator terminal comprises the storage unit. The storage unit is in particular formed by an internal storage of the operator terminal.

In this context, data being “classified” is in particular understood to mean that data is subdivided into ranges, in particular classes, as a function of a value, as a function of a value deviation, as a function of a value curve, as a function of an integral of the value curve, whereby only data falling into the range, in particular the class, is considered, and in particular stored, as compressed operating data. The data is in particular formed by raw signals from the electronics unit of the hand-held power tool, e.g., current, voltage, temperature, speed, or the like. The data can, for example, be subdivided directly into multiple classes, wherein it is calculated for how long which class existed. A corresponding duration and/or frequency can be stored accordingly. Alternatively or additionally, a load change classification can be performed using the data, such as a range pair or a rainflow classification. It is thus calculated in particular which changes of the value of the data, such as the current, occur how often. As a result, the raw current signal is not transferred, rather only a classification of the data strokes. The classification can be 1-dimensional with the height of the load change or also 2-dimensional with the start and target class. Alternatively or additionally, with the aid of the data, in particular using power, current, and voltage data, it can be determined how long the hand-held power tool is operated within a power range during a usage. Duration can be classified for different performance ranges. In particular, linear or non-linear class widths are possible. The usage case can, for example, start as soon as a certain load level is applied, for example 500-800 W, and the usage case is ended and stored as soon as the load level is no longer applied. Alternatively or additionally, data, in particular the raw data, can be temporarily stored for classification for a predefined period of time, e.g. 10 minutes, in a circular buffer. Using this cached data, it can then be determined how high the mean value, e.g. a current, was in the last seconds, e.g. during the last 1 s, 5 s, 10 s, or the like. The average value of the data over a certain period of time can also be performed via the storage of the current integral at different points in time. The mean current over the period a is calculated as the difference of the current integral between time x and time x−a. Only which maximum current was applied for these periods is stored. If a higher average current is determined for a certain period of time, then the previous value is overwritten. Alternatively or additionally, a fast Fourier transformation, e.g. vibration data, can be used in order to determine which frequency range is stimulated at what amplitude. As a result, the raw vibration data are not transferred, but rather only a classification via the frequency bands.

In this context, data being “evaluated in order to detect a defined event” is in particular intended to mean that data of the operating parameters of the hand-held power tool are evaluated in order to detect events of the hand-held power tool. In particular, the computing unit interprets in particular a plurality of data of the operating parameters, in particular over a defined period of time, whereby an event is inferred, in particular from a duration and/or a coincidence of different data. A variety of events which a skilled person would consider advantageous and which may be relevant to documentation are conceivable. In particular, events can include, e.g., dropping the hand-held power tool, an error, in particular an error message, a battery change, in particular a state of charge during a battery change, a pause time, a setting down of the hand-held power tool, in particular a length of a setting down of the hand-held power tool, and/or the like.

In particular, advantageous documentation of operating data of the hand-held power tool can be achieved using the inventive design of the method for documentation of operating data of a hand-held power tool. In particular, an option for storing electronics, in particular a device electronics, of the hand-held power tool can be extended, in particular increased. Furthermore, the method can significantly reduce a storage requirement on the data processing device.

Further options for processing the data for data reduction are also conceivable. It is, for example, conceivable that only a mean value or median of the raw signal, e.g., a current, a voltage, a speed, or the like, be calculated and stored in a counter. Alternatively or additionally, it is conceivable that only the integral of a raw signal, e.g., a current or a voltage, be calculated and stored in a counter. Alternatively or additionally, it is conceivable that only the derivative, i.e. the slope, of a raw signal, e.g. a current, a voltage, a speed, a temperature, an acceleration, or the like, be calculated. The calculated value can be stored as either a time series or classified as a histogram. Alternatively or additionally, instead of an entire period of time, only a predefined period of time can be stored and permanently overwritten as soon as new data is created.

It is further proposed that the computing unit store a number and/or a time of detected, defined events on the storage unit in at least one method step, in particular in the storage step. Preferably, in at least one method step, in particular in the storage step, the computing unit stores a number and in particular a duration of detected, defined events on the storage unit. In particular, only storage of the type of event (as well as optionally a time and/or a duration of the event) is performed, whereby evaluated data which were the basis for detecting the event are not further considered for storage. In particular, a specific event time can be stored as the times of detected and defined events. The timing can be done using a real-time clock in particular. For this purpose, a real-time stamp of a real-time clock can in particular be stored for an event. For example, the timing of an event, such as a battery change, a dropping of the hand-held power tool, an overload, a fault, or the like, can be reliably stored. As an event, it can, e.g., be detected whether and from what height the device was dropped based on acceleration data. This is determined in particular based on the time at an acceleration in a vertical direction greater than 1 g. Preferably, as a result, in particular, only the drop as well as a dropping height, in particular a dropping height range, is stored. Alternatively or additionally, the data of the operating parameters of the hand-held power tool, in particular raw data and/or calculated data, is permanently cached. As soon as a predefined event occurs, e.g., an error or a special usage case, the last seconds or minutes are permanently stored. Information about the event is also stored, e.g., an event type, a run time of the motor of the hand-held power tool, a temperature, a location of the hand-held power tool, or the like. Alternatively or additionally, a number of battery changes can be detected on the hand-held power tool. A voltage signal is used in particular in order to determine whether a battery change has been performed. If the idle voltage increases by a certain percentage, this is preferably identified as a battery change and stored in a counter. In addition, the current flow rate, i.e. in particular a current integral, between two battery changes can also be stored in a histogram. Alternatively or additionally, a state of charge of the battery can be detected. The current state of charge can be determined via the idle voltage of the battery. The state of charge can thereby be stored in a histogram before and after each battery change. Optionally, the battery type can also be stored for a battery change. Alternatively or additionally, pause times can be recorded and stored as events. Using a real-time clock, the data processing device can determine how long the pause times are between two usage cases. It can then be counted in a histogram how frequently the pause length occurs. Alternatively or additionally, the acceleration data in the x, y, and z directions after smoothing across multiple signal points and filters (low-pass filter) can be used in order to calculate the spherical angles. This results in how long the hand-held power tool was and in which position. As a result, a position of the hand-held power tool can be stored as an event. In addition, the duration can also be stored in the respective position. As a result, an advantageous documentation of an operation of the hand-held power tool can in particular be achieved. Furthermore, the method can significantly reduce a storage requirement on the data processing device.

It is further proposed that the computing unit stores classified data as a histogram in at least one method step, in particular in the storage step. Preferably, a frequency distribution of individual classes in which the data of the operating parameters have been classified is stored using the computing unit. Preferably, a frequency distribution stored on the storage unit is continuously adjusted by the computing unit. Preferably, data of the operating parameters of the hand-held power tool are evaluated using the computing unit and respectively subdivided into one of the stored classes, whereby a frequency and/or a duration of the respective classes are stored in the histogram. As a result, an advantageous documentation of an operation of the hand-held power tool can in particular be achieved. Furthermore, the method can significantly reduce a storage requirement on the data processing device.

It is further proposed that, in at least one method step, in particular in the processing step, the computing unit can perform a load change classification for at least one operating parameter of the received operating parameters of the hand-held power tool. Preferably, in at least one method step, in particular in the processing step, a load change classification is performed by the computing unit using the data, e.g., a range pair or a rainflow classification. It is thereby calculated in particular which changes of the value of the data, e.g. the current, occur and how often. As a result, the raw current signal is not transferred, but rather only a classification of the data strokes. The classification can be 1-dimensional with the height of the load change or also 2-dimensional with the start and target class. As a result, an advantageous documentation of an operation of the hand-held power tool can in particular be achieved. Furthermore, the method can significantly reduce a storage requirement on the data processing device.

It is further proposed that, in at least one method step, in particular in the processing step, the computing unit can evaluate operating data of the hand-held power tool in order to identify a battery change on the hand-held power tool and store an associated event on the storage unit. Preferably, a number of battery changes on the hand-held power tool are detected by the computing unit in at least one method step, in particular in the processing step. A voltage signal is used in particular in order to determine whether a battery change has been performed. If the idle voltage increases by a certain percentage, this is preferably identified as a battery change and stored in a counter. In addition, the current flow rate, i.e., in particular a current integral, between two battery changes can also be stored in a histogram. Preferably, the computing unit is provided in order to store at least a number and/or a time of battery changes on the storage unit. As a result, an advantageous documentation of battery changes of the hand-held power tool can in particular be achieved. Furthermore, the method can minimize a storage requirement on the data processing device.

In addition, it is proposed that the computing unit, in at least one method step, in particular in the processing step, determines a state of charge of a battery before and after a battery change on the hand-held power tool and, in at least one method step, in particular in the storage step, stores an associated piece of information on the storage unit. Preferably, a state of charge of the battery is detected by the computing unit in at least one method step, in particular in the processing step. The current state of charge can be determined via the idle voltage of the battery. The state of charge can thereby be stored in a histogram before and after each battery change. Optionally, the battery type can also be stored in case of a battery change. As a result, an advantageous documentation of battery changes as well as boundary conditions of the battery change can in particular be achieved. Furthermore, the method can minimize a storage requirement on the data processing device.

Furthermore, it is proposed that, in at least one method step, in particular in the processing step, the computing unit evaluates at least acceleration data of the hand-held power tool in order to identify a defined event, such as in particular a setting down and/or a dropping of the hand-held power tool, and store it on the storage unit. Preferably, in at least one method step, in particular in the processing step, the computing unit detects whether and from what height the hand-held power tool is dropped based on acceleration data. This is determined in particular based the time at an acceleration in a vertical direction of greater than 1 g. Preferably, only the fall as well as a dropping height, in particular a dropping height range, is stored in the storage step on the storage unit. Alternatively or additionally, the acceleration data in the x, y, and z directions after smoothing across multiple signal points and filters (low-pass filter) can be used in order to calculate the spherical angles. This results in how long the hand-held power tool was in which position. As a result, a setting down of the hand-held power tool can be stored as an event. In addition, the duration can also be stored in the respective position. As a result, an advantageous documentation of events of the hand-held power tool can in particular be achieved. Furthermore, the method can minimize a storage requirement on the data processing device.

It is further proposed that the computing unit stores a duration of the defined event on the storage unit in at least one method step, in particular in the storage step. Preferably, in at least one method step, in particular in the storage step, the computing unit stores a number and a duration of detected, defined events on the storage unit. It is in particular conceivable that the duration of identical events be accumulated on the storage unit. Alternatively, it is also conceivable that the results be stored individually along with the corresponding duration. It would be further conceivable the results also be classified by duration. It would then be conceivable that, e.g., the events be stored in a matrix according to the result of two from among a range of durations. As a result, an advantageous documentation of events of the hand-held power tool can in particular be achieved. Furthermore, the method can minimize a storage requirement on the data processing device.

Furthermore, the invention proceeds from a data processing device, in particular a data logger, for the hand-held power tool for performing a method, said device having a communication unit for communicating with an electronics unit of the hand-held power tool, a computing unit configured to process operating parameters of the hand-held power tool received via the communication unit into compressed operating data in order to reduce the storage requirement; and a storage unit for storing the operating data of the hand-held power tool processed, in particular compressed, by the computing unit.

Furthermore, the invention proceeds from a hand-held power tool system having a hand-held power tool and the data processing device. It is proposed that the hand-held power tool system comprise an operator terminal, in particular a smartphone, into which the data processing device, in particular in the form of a smartphone application, is integrated. The data processing device is preferably at least partially formed by an application executed on the operator terminal. Preferably, the data processing device uses a communication unit of the operator terminal as a communication unit. Preferably, the data processing device uses a computing unit of the operator terminal as a computing unit. Particularly preferably, the data processing device uses a storage unit of the operator terminal as a storage unit. Alternatively, it is also conceivable for the data processing device to be at least partially connected to a server, in particular a cloud, on which data of the storage unit can be stored. In this context, an “operator terminal” is understood in particular to mean a device for direct or indirect communication with an operator. Preferably, this is intended to mean in particular an operator-associated device. Preferably, this should in particular be understood to mean a mobile terminal for communicating with an operator. Various operator terminals which a skilled person regards as advantageous are also conceivable. However, such devices are understood in particular to be a computer, a smartphone, a tablet PC, a wearable computer, in particular a smartwatch, and/or a data goggle, in particular an AR eyewear, and/or a peripheral head-mounted display (PHMD). In particular, a smartphone or tablet computer is preferred as the operator terminal. A number of smartphone and tablet systems exist on the market. Preferably, the operator terminal in particular comprises a storage unit, a computing unit, and/or a communication unit. Particularly preferably, the operator terminal is in particular able to be held by hand. In particular, an advantageous hand-held power tool system can thereby be provided. Preferably, the hand-held power tool in particular can thereby advantageously remain compact. Furthermore, the data processing device can in particular be integrated into a device that has sufficient processing power and/or storage space. In particular, the data processing device can be integrated into a device which advantageously has direct internet access. In particular, this can enable a direct evaluation and/or forwarding of the compressed operating data.

It is further proposed that the data processing device comprise at least one housing that is provided for a releasable connection with the hand-held power tool. Preferably, the data processing device is formed by a stand-alone module, which can be coupled to the hand-held power tool via an interface, in particular a physical interface, and/or in a housing of the hand-held power tool. Preferably, the hand-held power tool has a defined slot for receiving the data processing device. As a result, an advantageous integration of the data processing device into the hand-held power tool can in particular be achieved. In particular, further devices can be omitted. In addition, in particular, it can be possible for the data processing device to be powered directly by the hand-held power tool. In addition, a direct data line can be enabled in particular, whereby a reliable data transfer can be achieved.

The method according to the invention and the data processing device are not intended to be limited to the application and embodiment described hereinabove. In particular, for fulfilling a functionality described herein, the method according to the invention and the data processing device can comprise a number of individual elements, components, units, and method steps that deviates from a number specified herein. Moreover, for the ranges of values indicated in this disclosure, values lying within the aforementioned limits are also intended to be considered to be disclosed and usable as desired.

### DRAWINGS

Further advantages follow from the following description of the drawings. The drawings illustrate two exemplary embodiments of the invention. The drawings, the description, and the claims contain numerous features in combination. A skilled person will appropriately also consider the features individually and combine them into additional advantageous combinations.

Shown are:

FIG. 1 a hand-held power tool system with a hand-held power tool and a data processing device in a schematic representation,

FIG. 2 a schematic flowchart of a method according to the invention for documenting operating data of the hand-held power tool using the data processing device,

FIG. 3 a schematic diagram of raw data of a current of the hand-held power tool with current classes drawn for classification,

FIG. 4 a schematic diagram of raw data of a current of the hand-held power tool with load changes drawn for classification,

FIG. 5 a schematic diagram of raw data of a power of the hand-held power tool with usages in defined load ranges drawn for classification,

FIG. 6 a schematic diagram of raw data of vibrations of the hand-held power tool over time for a classification,

FIG. 7 a schematic diagram of raw data of axis-specific vibrations of the hand-held power tool over time for a positional detection, and

FIG. 8 an alternative hand-held power tool system having a hand-held power tool with an operator terminal and with a data processing device integrated into the operator terminal in a schematic representation.

### DESCRIPTION OF THE EXEMPLARY EMBODIMENTS

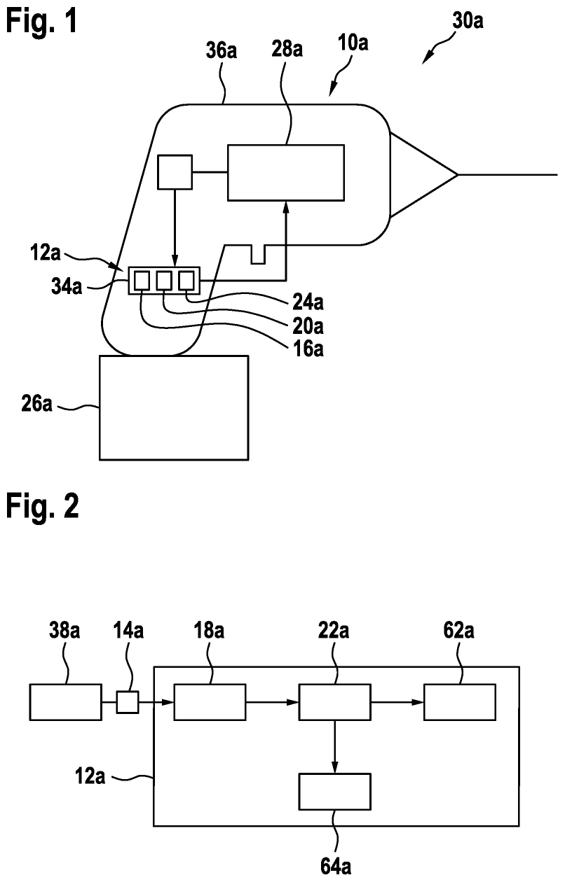

FIG. 1 shows a hand-held power tool system 30a with a hand-held power tool 10a and with a data processing device 12a. The hand-held power tool 10a is, e.g., formed by a cordless screwdriver. However, a different design for the hand-held power tool 10a which a skilled person regards as advantageous would also be conceivable. The hand-held power tool 10a comprises a drive formed by an electric motor (not further shown). Furthermore, the hand-held power tool 10a comprises a battery 26a, which is provided for a power supply of the drive. The battery 26a is releasably connected to a housing 36a of the hand-held power tool 10a via a battery interface. The battery 26a can be removed from the housing 36a of the hand-held power tool 10a for charging. Furthermore, the hand-held power tool 10a comprises an electronics unit 28a. The electronics unit 28a is formed by device electronics. The electronics unit 28a is provided in order to control an operation of the hand-held power tool 10a. Furthermore, the electronics unit 28a is provided in order to collect operating data, in particular operating parameters, of the hand-held power tool 10a. For this purpose, the electronics unit 28a is in particular coupled to sensors of the hand-held power tool 10a (not further shown). In addition, the electronics unit 28a is provided in order to supply power to the drive of the hand-held power tool 10a with a power of the battery 26a. The electronics unit 28a detects at least one among a current, a voltage, a temperature, and a speed of the drive of the hand-held power tool 10a. Furthermore, the electronics unit 28a detects vibrations and/or an acceleration of the hand-held power tool 10a.

The data processing device 12a is provided for documentation of operating data of the hand-held power tool 10a. The data processing device 12a is provided in order to document operating data of the hand-held power tool 10a, independently from the hand-held power tool 10a and in particular from the integrated electronics unit 28a of the hand-held power tool 10a. Additionally, the data processing device 12a can be provided for an evaluation of the operating data of the hand-held power tool 10a. It is in particular conceivable that the data processing device 12a can be provided for an automatic evaluation of the operating data of the hand-held power tool 10a and for an automatic adjustment of characteristics of the hand-held power tool 10a as a function of the documented operating data. The data processing device 12a is formed by a data logger. The data processing device 12a is formed by a mini data logger. The data processing device 12a is for the hand-held power tool 10a. The data processing device 12a is provided for documentation of operating data of the hand-held power tool 10a, in particular in the long term. The data processing device 12a comprises a housing 34a. The data processing device 12a is formed by a stand-alone module, which can be coupled to the hand-held power tool 10a via an interface, in particular a physical interface, on the housing 36a of the hand-held power tool 10a. The hand-held power tool 10a comprises a defined slot on the housing 36a, in particular a physical interface, for receiving the data processing device 12a. The data processing device 12a is provided via the housing 34a for a releasable connection with the hand-held power tool 10a.

The data processing device 12a comprises a communication unit 16a. The communication unit 16a is provided for communication with the electronics unit 28a of the hand-held power tool 10a. In particular, stored data of the electronics unit 28a of the hand-held power tool 10a is retrieved using the communication unit 16a using the data processing device 12a. The stored data can in particular be read in a wired manner or transferred wirelessly, e.g., via Bluetooth, mobile radio, LoRa, WiFi, or the like. The communication unit 16a in this embodiment is provided for directly contacting contacts of a data interface of the hand-held power tool 10a (not further shown). The communication unit 16a is connected to the electronics unit 28a via the data interface for data transfer. The data interface is in particular integrated into the slot of the hand-held power tool 10a for the data processing device 12a. In principle, it is also conceivable that data transfer between the electronics unit 28a and the communication unit 16a be wireless.

The data processing device 12a further comprises a computing unit 20a. The computing unit 20a comprises a processor provided for the processing of data. The computing unit 20a is configured to process operating parameters received via the communication unit 16a of the hand-held power tool 10a into compressed operating data in order to reduce a storage requirement. Furthermore, the computing unit 20a is provided in order to store the compressed operating data on a storage unit 24a of the data processing device 12a. The data processing device 12a comprises the storage unit 24a. The storage unit 24a is formed by a data store. The storage unit 24a is, e.g., formed by a storage chip. The storage unit 24a is provided for storing the compressed operating data of the hand-held power tool 10a processed by the computing unit 20a.

The communication unit 16a, computing unit 20a, and storage unit 24a are arranged within the housing 34a of the data processing device 12a. The data processing device 12a forms a completed module. The data processing device 12a can in particular be coupled to various hand-held power tools 10a.

FIG. 2 shows a schematic flowchart of a method for documenting operating data of the hand-held power tool 10a using the data processing device 12a. The method is used to document operating data of the hand-held power tool 10a using the data processing device 12a. In the method, in a detection step 38a, operating parameters of the hand-held power tool 10a are detected using the electronics unit 28a. For example, a power supply, a temperature, and/or a speed of the drive of the hand-held power tool 10a are monitored. It is in particular conceivable that the detected operating parameters can be temporarily stored. Furthermore, the method comprises a communication step 14a. The communication step 14a in particular follows the detection step 38a. However, it is also conceivable that further method steps be interposed. In the communication step 14a, the operating parameters of the hand-held power tool 10a are retrieved via the communication unit 16a of the data processing device 12a. The operating parameters of the hand-held power tool 10a are transferred directly to the data processing device 12a via the data interface.

Furthermore, the method comprises a processing step 18a. The processing step 18a in particular follows the communication step 14a. However, it is also conceivable that further method steps be interposed. In the processing step 18a, the operating parameters of the hand-held power tool 10a are processed by a computing unit 20a of the data processing device 12a into compressed operating data in order to reduce a storage requirement. The computing unit 20a, in the processing step 18a, classifies data of the received operating parameters of the hand-held power tool 10a for a generation of the compressed operating data. Additionally, in the processing step 18a, the computing unit 20a evaluates data of the received operating parameters of the hand-held power tool 10a for a detection of a defined event. Various manners of processing the data of the received operating parameters of the hand-held power tool 10a by the computing unit 20a are conceivable. It is conceivable that the data be classified differently as a function of a type of data and/or evaluated for a detection of a defined event, or that the data be classified in the same type or evaluated regarding a detection of a defined event. The methods described hereinafter are therefore applicable both individually and in combination.

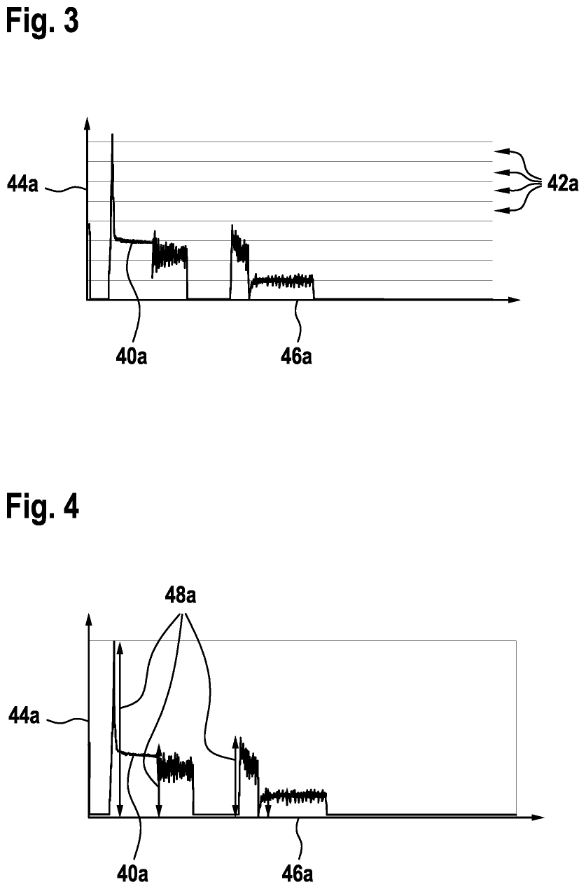

The computing unit 20a can perform a classification in the processing step 18a for at least one operating parameter of the received operating parameters of the hand-held power tool 10a, e.g. the current. The operating parameter is divided directly into several classes as a function of a value, whereby it is calculated how long which class existed. A corresponding duration and/or frequency can be stored accordingly. FIG. 3 shows a schematic diagram of raw data 40a of a current of the hand-held power tool 10a with current classes 42a drawn for a classification. In the diagram, the current in amperes is the ordinates 44a and the time in seconds is the abscissa 46a. The raw data 40a is processed by the computing unit 20a, respectively, whereby the computing unit 20a detects at what frequency which current class 42a is present. For example, current classes 42a from 0 A to 5 A, from 5 A to 10 A, from 10 A to 15 A, from 15 A to 20 A, from 20 A to 25 A, from 25 A to 30 A, from 30 A to 35 A, and from 35 A to 40 A are in this case conceivable. However, other current classes 42a which a skilled person regards as advantageous are also generally conceivable.

Alternatively or additionally, in one method step, in particular in the processing step 18a, the computing unit 20a can perform a load change classification for at least one operating parameter of the received operating parameters of the hand-held power tool 10a. In this case, a load change classification is performed by the computing unit 20a in the processing step 18a using the data, for example a range pair or a rainflow classification. It is thereby calculated which changes of the value of the data, such as the current, occur how often. As a result, the raw current signal is not stored as operating data, but rather only a classification of the data strokes. The classification can be 1-dimensional with the height of a load change 48a or also 2-dimensional with the start and target class. FIG. 4 shows a schematic diagram of the raw data 40a of the current of the hand-held power tool 10a with load changes 48a drawn for classification. In the diagram, the current in amperes is the ordinates 44a and the time in seconds is the abscissa 46a. The raw data 40a is processed by the computing unit 20a, accordingly, whereby the computing unit 20a detects the frequency at which load change classes of the load change 48a are present, i.e., at what frequency load change 48a occur in what value range. For example, load change classes from 0 A to 5 A, from 5 A to 10 A, from 10 A to 15 A, from 15 A to 20 A, from 20 A to 25 A, from 25 A to 30 A, from 30 A to 35 A, and from 35 A to 40 A are in this case conceivable. However, other load change classes which a skilled person regards as advantageous are also conceivable.

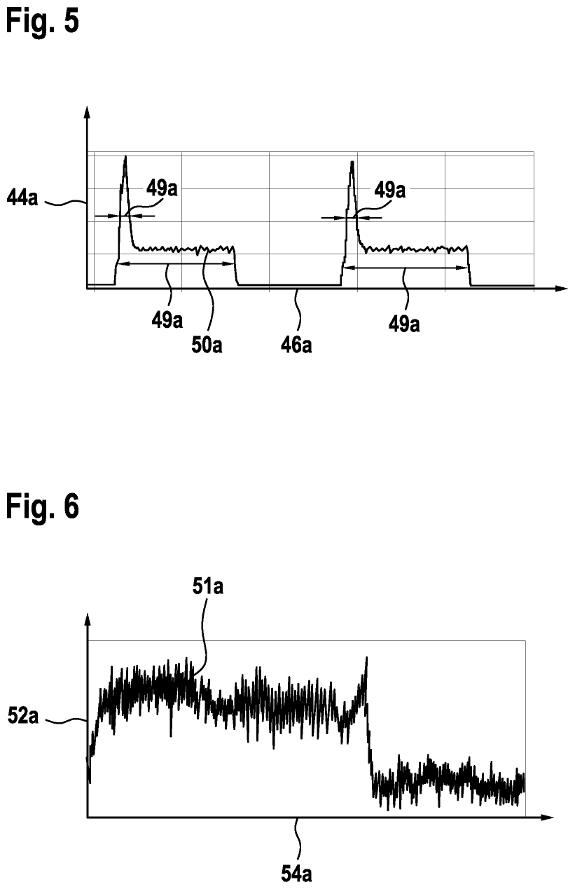

Alternatively or additionally, in one method step, in particular in the processing step 18a, the computing unit 20a can classify a duration of usage in a certain load range for at least one operating parameter of the received operating parameters of the hand-held power tool 10a. The computing unit 20a, in the processing step 18a, uses the data, in particular power, current, and voltage data, to determine how long the hand-held power tool 10a is operated within a power range during a usage. The duration can be classified for various performance ranges. In particular, linear or non-linear class widths are possible. The usage case can, e.g., start as soon as a certain load level is applied, e.g. 500-800 W and the usage case is ended and stored as soon as the load level is no longer applied. FIG. 5 shows a schematic diagram of the raw data 50a of a power of the hand-held power tool 10a with usages 49a in defined load ranges drawn in for classification. In the diagram, the power in watts is the ordinates 44a and the time in seconds is the abscissa 46a. The raw data 50a are processed by the computing unit 20a, accordingly, whereby the computing unit 20a detects at what frequency and in what duration, in particular in what time range, what power ranges exist, i.e., at what frequency for how long the hand-held power tool 10a is operated in what power range. For example, duration classes from 0 s to 1 s, from 1 s to 5 s, from 5 s to 15 s, from 15 s to 30 s, from 30 s to 60 s and greater than 60 s are conceivable in this case, whereby from 500 to 800 W and greater than 800 W are conceivable as the power range. However, other duration classes and power ranges which a skilled person regards as advantageous are also conceivable.

Alternatively or additionally, in one method step, in particular in the processing step 18a, the computing unit 20a can classify a maximum current over a certain period of time for at least one operating parameter of the received operating parameters of the hand-held power tool 10a. For this purpose, data, in particular the raw data, is temporarily stored for classification for a predefined period of time, e.g. 10 minutes, in a circular buffer by the computing unit 20a. Using this cached data, it can then be determined how high the mean value, e.g. a current, was during the last x seconds, e.g. during the last 1 s, 5 s, 10 s, or the like. The average value of the data over a certain period of time a can also be performed via the storage of the current integral at different points in time. The mean current over the period a is calculated as the difference of the current integral between time x and time x−a. Only which maximum current was applied for these periods is stored. If a higher average current is determined for a certain period of time, then the previous value is overwritten.

Alternatively or additionally, in one method step, in particular in the processing step 18a, the computing unit 20a can generate vibrations over the one classification via the frequency bands for at least one operating parameter of the received operating parameters of the hand-held power tool 10a. For this purpose, a fast Fourier transformation, e.g. vibration data, is used in order to determine which frequency range is stimulated at what amplitude. As a result, the raw vibration data is not transferred, rather only a classification via the frequency bands. FIG. 6 shows a schematic diagram of raw data 51a of vibrations of the hand-held power tool 10a. In the diagram, the vibrations in m/s² are the ordinates 52a and the time in seconds is the abscissa 54a. The raw data 51a are processed by the computing unit 20a, respectively, whereby the computing unit 20a detects at what amplitude what frequency range is stimulated.

Alternatively or additionally, in one method step, in particular in the processing step 18a, the computing unit 20a can evaluate operating data of the hand-held power tool 10a in order to identify a battery change on the hand-held power tool 10a and store an associated event on the storage unit 24a. A number of battery changes on the hand-held power tool 10a is detected by the computing unit 20a in the processing step 18a. A voltage signal is used in order to determine whether a battery change has been performed. If the idle voltage increases by a certain percentage, this is identified as a battery change and stored in a counter. In addition, the current flow rate, i.e., in particular a current integral, between two battery changes can also be stored in a histogram. The computing unit 20a is provided in order to store a number or a time of battery changes on the storage unit 24a. Additionally, in the processing step 18a, the computing unit 20a can determine a state of charge of the battery 26a before and after a battery change on the hand-held power tool 10a and, correspondingly, store related information on the storage unit 24a in a storage step 22a. For this purpose, a state of charge of the battery 26a is detected by the computing unit 20a in the processing step 18a. The current state of charge is determined via the idle voltage of the battery 26a. The state of charge can thereby be stored in a histogram before and after each battery change. Optionally, the battery type can also be stored in case of a battery change.

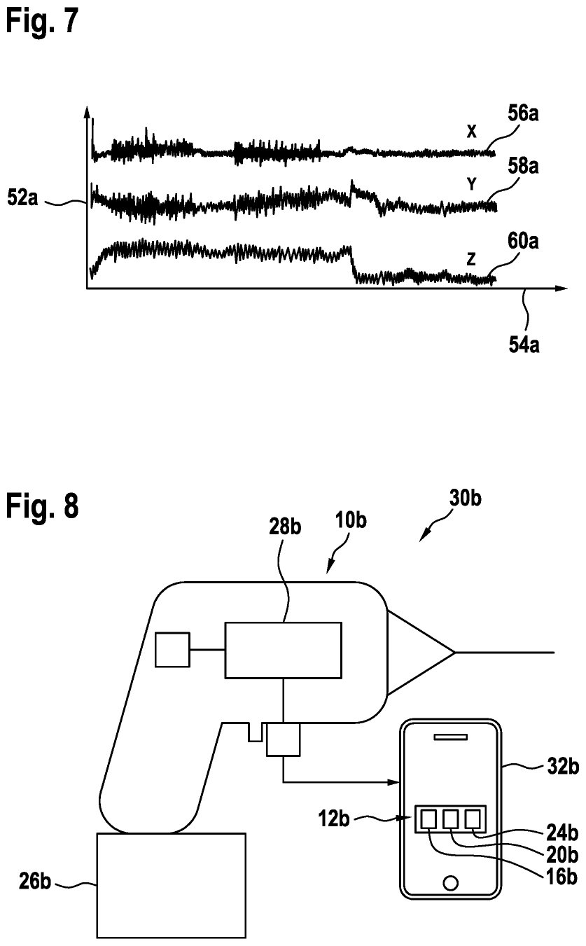

Alternatively or additionally, in one method step, in particular in a processing step 18a, the computing unit 20a can evaluate acceleration data of the hand-held power tool 10a in order to identify a defined event, e.g., in particular a setting down and/or a dropping of the hand-held power tool 10a, and store it on the storage unit 24a. For this purpose, in the processing step 18a, the computing unit 20a uses acceleration data in order to detect whether and from what height the hand-held power tool 10a was dropped. This is determined from the time at an acceleration in a vertical direction of greater than 1 g. As a result, only the fall as well as a dropping height, in particular a dropping height range, is stored in the storage step 22a on the storage unit 24a. Alternatively or additionally, the acceleration data in the x, y, and z directions after smoothing across multiple signal points and filters (low-pass filter) can be used in order to calculate the spherical angles. This results in how long the hand-held power tool 10a was in which position. As a result, a setting down of the hand-held power tool 10a can be stored as an event. In addition, the duration can also be stored in the respective position. FIG. 7 shows a schematic diagram of raw data 56a, 58a, 60a of axis-specific vibrations of the hand-held power tool 10a over time for a positional detection. The vibrations are determined separately for each axis. In the diagram, the vibrations in m/s² are the ordinates 52a, and the time in seconds is the abscissa 54a. The raw data 56a, 58a, 60a are processed accordingly by the computing unit 20a, whereby it is detected by the computing unit 20a in which position, e.g., horizontally upward, vertically or horizontally downwardly, the hand-held power tool 10a has been stored and for how long.

Alternatively or additionally, in processing step 18a, the computing unit 20a can permanently cache the data of the operating parameters of the hand-held power tool 10a, in particular raw data and/or calculated data, wherein as soon as a predefined event occurs, e.g., an error or a special usage case, the last seconds or minutes are permanently stored. Also, information about the event is stored, such as an event type, a run time of the drive of the hand-held power tool 10a, a temperature, a location of the hand-held power tool 10a, or the like.

Alternatively or additionally, in the processing step 18a, the computing unit 20a can detect and store pause times as events. Using a real-time clock, the data processing device 12a can determine how long the pause times are between two usage cases. It can then be counted in a histogram how frequently the pause length occurs.

Further options for processing the data for data reduction using the computing unit 20a in the processing step 18a are also conceivable. It is, e.g., conceivable that only a mean value or median of the raw signal, e.g., a current, a voltage, a speed, or the like be calculated and stored in a counter. Alternatively or additionally, it is conceivable that only the integral of a raw signal, e.g. a current or a voltage, be calculated and stored in a counter. Alternatively or additionally, it is conceivable that only the derivative, i.e. the slope, of a raw signal, e.g. a current, a voltage, a speed, a temperature, an acceleration, or the like, be calculated. The calculated value can be stored as either a time series or classified as a histogram. Alternatively or additionally, instead of an entire period of time, only a predefined period of time can be stored and permanently overwritten as soon as new data is created.

The method also comprises a storage step 22a. The storage step 22a in particular follows the processing step 18a. However, it is also conceivable that further method steps be interposed. In the storage step 22a, the compressed operating data of the hand-held power tool 10a processed by the computing unit 20a is stored on the storage unit 24a of the data processing device 12a. In the storage step 22a, the computing unit 20a stores a number and/or a time of detected, defined events on the storage unit 24a or classified data as a histogram. In the storage step 22a, the computing unit 20a can store in particular a duration of the defined event on the storage unit 24a.

The stored compressed operating data of the hand-held power tool 10a can then be sent out in a sending step 62a. For example, the processed, compressed operating data of the hand-held power tool 10a can be sent back to the electronics unit 28a for further use, e.g., for predictive maintenance, for application recommendations for the user, or for an AI of the hand-held power tool 10a. Sending can occur in both a wireless and wired manner via the interface.

Furthermore, the stored, compressed operating data of the hand-held power tool 10a can be read in a readout step 64a. The stored operating data can in particular be read in a wired manner or transferred wirelessly, e.g., via Bluetooth, mobile radio, LoRa, WiFi, or the like. The compressed operating data can be retrieved and read for error analysis, optimization of the hand-held power tool 10a, maintenance purposes, and/or adjustment of operating parameters of the hand-held power tool 10a.

FIG. 8 shows a further exemplary embodiment of the invention. The following descriptions and the drawings are substantially limited to the differences between the exemplary embodiments, whereby reference can basically also be made to the drawings and/or the description of the other exemplary embodiments, in particular FIGS. 1 to 7, with respect to identically designated components, in particular with respect to components having the same reference characters. In order to distinguish between the exemplary embodiments, the letter a has been added to the reference characters for the exemplary embodiment in FIGS. 1 to 7. In the exemplary embodiment shown in FIG. 8, the letter a is replaced by the letter b.

FIG. 8 shows a hand-held power tool system 30b with a hand-held power tool 10b, an operator terminal 32b, and a data processing device 12b. The hand-held power tool 10b is formed, e.g., by a cordless screwdriver. The hand-held power tool 10b further comprises an electronics unit 28b. The electronics unit 28b is formed by a device circuitry.

The data processing device 12b is provided for documentation of operating data of the hand-held power tool 10b. The data processing device 12b is provided in order to document operating data of the hand-held power tool 10b, independently from the hand-held power tool 10b and in particular from the integrated electronics unit 28b of the hand-held power tool 10b. The data processing device 12b comprises a communication unit 16b. The communication unit 16b is provided for communication with the electronics unit 28b of the hand-held power tool 10b. The communication unit 16b is connected to the electronics unit 28b for wireless data transfer. The communication unit 16a is formed by a Bluetooth module, by way of example. The data processing device 12b further comprises a computing unit 20b. The computing unit 20b is configured so as to process operating parameters received via the communication unit 16b of the hand-held power tool 10b into compressed operating data in order to reduce a storage requirement. Furthermore, the computing unit 20b is provided in order to store the compressed operating data on a storage unit 24b of the data processing device 12b. The data processing device 12b comprises the storage unit 24b.

The operator terminal 32b is formed by a smart phone, by way of example. The data processing device 12b is integrated into the operator terminal 32b in the form of a smartphone application. The data processing device 12b is preferably at least partially formed by an application executed on the operator terminal 32b. As the communication unit 16b, the data processing device 12b uses a communication unit of the operator terminal 32b. Furthermore, as the computing unit 20b, the data processing device 12b uses a computing unit of the operator terminal 32b. Furthermore, as the storage unit 24b, the data processing device 12b uses a storage unit of the operator terminal 32b.

1. A method for documenting operating data of a hand-held power tool using a data processing device, comprising:
retrieving operating parameters of the hand-held power tool using a communication unit of the data processing device;
processing the received operating parameters of the hand-held power tool into compressed operating data using a computing unit of the data processing device in order to reduce a storage requirement of the operating parameters; and
storing the compressed operating data of the hand-held power tool which is processed by the computing unit on a storage unit of the data processing device,
wherein processing the received operating parameters includes (i) classifying data of at least one operating parameter of the received operating parameters of the hand-held power tool in order to generate the compressed operating data using the computing unit, and/or (ii) evaluating the compressed operating data in order to detect a defined event using the computing unit.

2. The method according to claim 1, wherein storing the compressed operating data further comprises:
storing a number and/or a time of detected, defined events on the storage unit using the computing unit.

3. The method according to claim 1, wherein storing the compressed operating data further comprises:
storing data classified as a histogram.

4. The method according to claim 1, wherein processing the received operating parameters further comprises:
performing a load change classification for at least one operating parameter of the received operating parameters of the hand-held power tool.

5. The method according to claim 1, wherein:
processing the received operating parameters further comprises evaluating the compressed operating data of the hand-held power tool in order to identify a battery change event on the hand-held power tool using the computing unit, and
storing the compressed operating data further comprises storing the battery change event on the storage unit.

6. The method according to claim 5, wherein:
processing the received operating parameters further comprises determining a state of charge event of a battery of the hand-held power tool before and after a battery change on the hand-held power tool using the computing unit, and
storing the compressed operating data further comprises storing the state of charge event on the storage unit.

7. The method according to claim 1, wherein:
processing the received operating parameters further comprises evaluating at least acceleration data of the hand-held power tool in order to identify an acceleration event corresponding to a setting down and/or a dropping of the hand-held power tool using the computing unit, and
storing the compressed operating data further comprises storing the acceleration event on the storage unit.

8. The method according to claim 7, wherein storing the compressed operating data further comprises storing a duration of the acceleration event on the storage unit using the computing unit.

9. A data processing device for a hand-held power tool including an electronics unit, the data processing device comprising:
a communication unit configured to communicate with an electronics unit of the hand-held power tool and to retrieve operating parameters of the hand-held power tool;
a computing unit operably connected to the communication unit and configured to process the received operating parameters of the hand-held power tool received via the communication unit into compressed operating data in order to reduce a storage requirement of the operating parameters; and
a storage unit operably connected to the computing unit and configured to store the compressed operating data of the hand-held power tool processed in particular compressed, by the computing unit,
wherein processing the received operating parameters includes (i) classifying data of at least one operating parameter of the received operating parameters of the hand-held power tool in order to generate the compressed operating data using the computing unit, and/or (ii) evaluating the compressed operating data in order to detect a defined event using the computing unit.

10. A hand-held power tool system comprising:
a hand-held power tool including an electronics unit; and
a data processing device including (i) a communication unit configured to communicate with the electronics unit and to retrieve operating parameters of the hand-held power tool, (ii) a computing unit operably connected to the communication unit and configured to process the received operating parameters of the hand-held power tool received via the communication unit into compressed operating data in order to reduce a storage requirement of the operating parameters, and (iii) a storage unit operably connected to the computing unit and configured to store the compressed operating data of the hand-held power tool processed by the computing unit,
wherein processing the received operating parameters includes (i) classifying data of at least one operating parameter of the received operating parameters of the hand-held power tool in order to generate the compressed operating data using the computing unit, and/or (ii) evaluating the compressed operating data in order to detect a defined event using the computing unit.

11. The hand-held power tool system according to claim 10, further comprising:
an operator terminal into which the data processing device is integrated as a smartphone application.

12. The hand-held power tool system according to claim 10, wherein the data processing device comprises at least one housing provided for a releasable connection with the hand-held power tool.
